(19) United States
(12) Patent Application Publication
(10) Pub. No.: US 2015/0043869 A1
(43) Pub. Date: Feb. 12, 2015

(54) OPTICAL FIBER CONNECTOR HAVING DETACHABLE FIRST BODY AND SECOND BODY

(71) Applicant: HON HAI PRECISION INDUSTRY CO., LTD., New Taipei (TW)

(72) Inventor: Chang-Wei KUO, New Taipei (TW)

(73) Assignee: HON HAI PRECISION INDUSTRY CO., LTD., New Taipei (TW)

(21) Appl. No.: 14/086,078

(22) Filed: Nov. 21, 2013

(30) Foreign Application Priority Data
Aug. 8, 2013 (TW) 102128549

(51) Int. Cl. G02B 6/36

(52) U.S. Cl. CPC G02B 6/36
USPC 385/53

(57) ABSTRACT

An optical fiber connector includes a first body, a second body, and an optical fiber group. The first body defines a clamping groove and at least one stepped through hole. The second body includes a clamping block and at least one connecting rod. A shape and a size of the clamping block are substantially identical to a shape and a size of the clamping groove. The clamping block is received in the clamping groove. A size of the connecting rod is smaller than a size of the stepped through hole. The connecting rod is received in the stepped through hole. A first curable glue is filled in the stepped through hole to fix the first body to the second body.

### BACKGROUND

1. Technical Field

The present disclosure relates to an optical fiber connector.

2. Description of Related Art

An optical fiber connector includes a main body and an optical fiber fixed on the main body. The main body is usually integrally formed by injection molding. However, the main body has a complex structure and is not easy to manufacture.

Therefore, it is desirable to provide an optical fiber connector that can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of an optical fiber connector according to an exemplary embodiment of the present disclosure.

FIG. 2 is an exploded view of the optical fiber connector of FIG. 1 without a curable glue.

FIG. 3 is similar to FIG. 2, but viewed from another angle.

FIGS. 4 through 6 show an assembling process of the optical fiber connector of FIG. 1.

### DETAILED DESCRIPTION

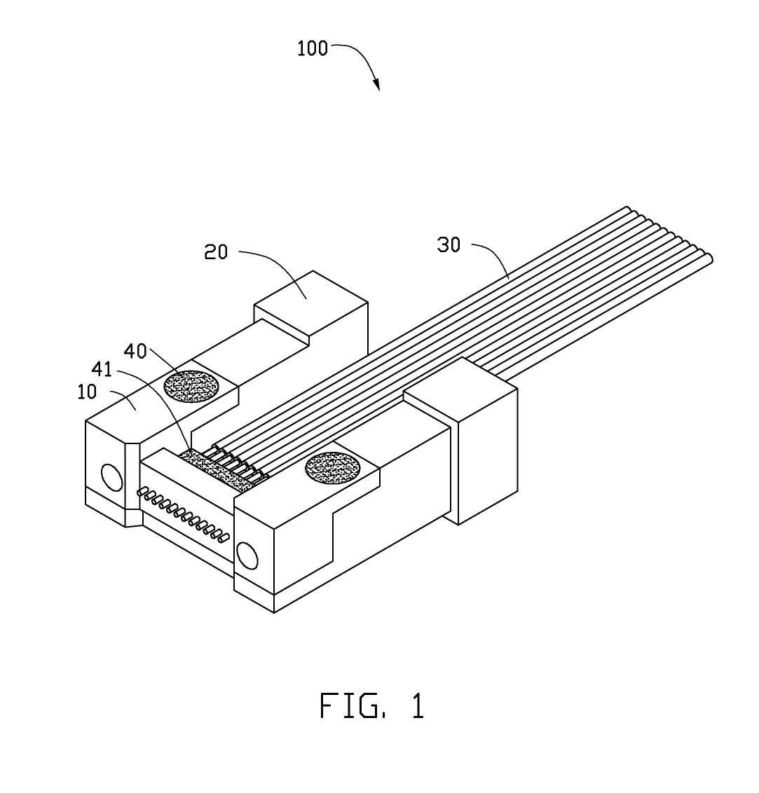

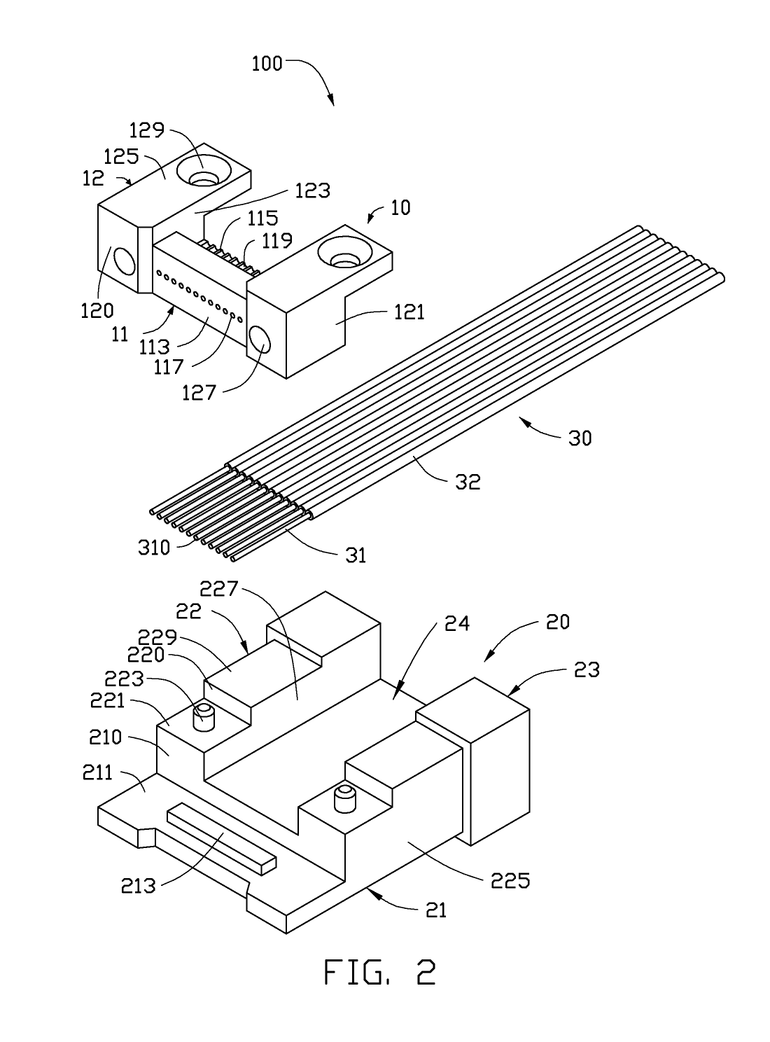

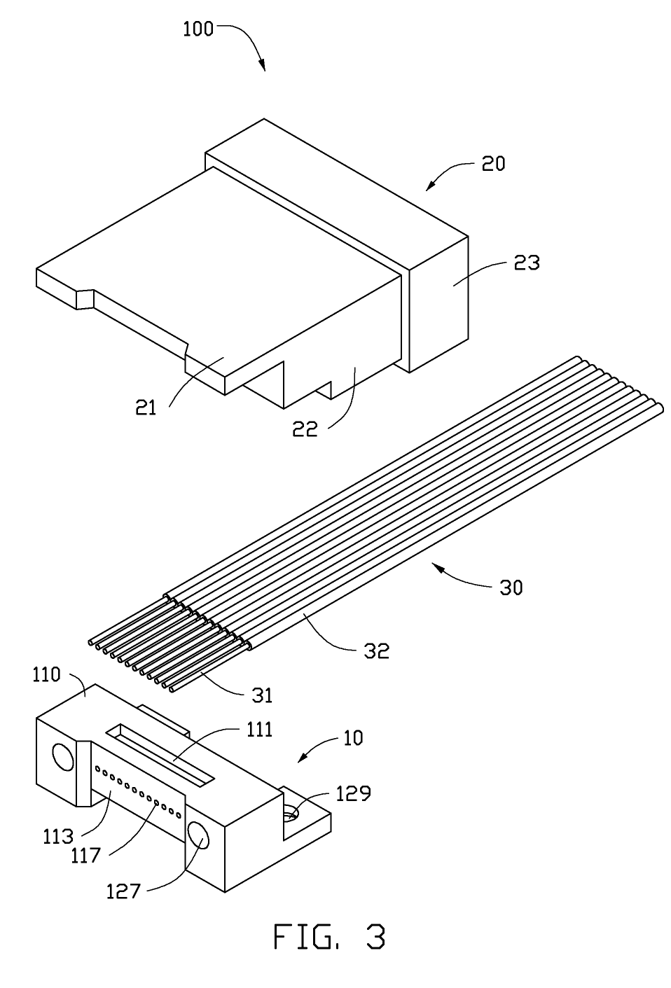

Referring to FIGS. 1 through 3, an optical fiber connector 100 according to an exemplary embodiment is disclosed. The optical fiber connector 100 includes a first body 10, a second body 20, and an optical fiber group 30. The first body 10 and the second body 20 are separately formed by injection molding.

The first body 10 includes an optical part 11 and two connecting parts 12 extending substantially perpendicularly from opposite ends of the optical part 11, respectively. The optical part 11 and the connecting parts 12 share a common bottom surface 110. The first body 10 defines a clamping groove 111 in the bottom surface 110. A cross-section of the first body 10 is substantially L-shaped. The optical part 11 includes a first front surface 113 connected substantially perpendicularly to the bottom surface 110, and a first top surface 115 opposite and substantially parallel to the bottom surface 110. The first front surface 113 defines a plurality of receiving holes 117 extending through the optical part 11. The optical part 11 further defines a plurality of receiving grooves 119 in the front top surface 115. The receiving holes 117 and the receiving grooves 119 are aligned one-to-one and communicate with each other. The receiving holes 117 and the receiving grooves 119 receive the optical fiber group 30.

Each connecting part 12 includes a second front surface 120, a first outer side surface 121, a first inner side surface 123, and a second top surface 125. The second front surface 120, the first outer side surface 121, and the first inner side surface 123 are substantially perpendicular to the bottom surface 110. The first outer side surface 121 is opposite and substantially parallel to the first inner side surface 123. The second top surface 125 is opposite and substantially parallel to the bottom surface 110. Each connecting part 12 defines an insertion hole 127 for engagingly receiving a positioning rod of another optical fiber connector (not shown). Each connecting part 12 further defines a stepped through hole 129 in the top surface 125. The top portion of the stepped through hole 129 is bigger than the lower portion of the stepped through hole 129 to receive glue.

The second body 20 includes a base 21, two sidewalls 22 extending substantially perpendicularly from two sides of the base 21, respectively, and a projection 23 projecting from a back side of the base 21 and the sidewalls 22. The base 21 and the sidewalls 22 cooperatively define a receiving space 24. The receiving space 24 receives the optical fiber group 30.

The base 21 includes a first step 210 and a first surface 211 adjacent to the first step 210. A clamping block 213 is formed on the first surface 211. A shape and a size of the clamping block 213 are substantially identical to a shape and a size of the clamping groove 111. The clamping block 213 is received in the clamping groove 111 to mount the first body 10 on the second body 20.

Each sidewall 22 includes a second step 220 and a second surface 221 adjacent to the second step 220. A connecting rod 223 is formed on the second surface 221. A size of the connecting rod 223 is smaller than a size of the stepped through hole 129. The connecting rod 223 is received in the stepped through hole 129 to mount the first body 10 to the second body 20.

Each sidewall 22 includes a second outer side surface 225, a second inner side surface 227 opposite and substantially parallel to the second outer side surface 225, and a third top surface 229 substantially perpendicular to the second outer side surface 225 and the second inner side surface 227. When the first body 10 is mounted on the second body 20, the first outer side surface 121 is coplanar with the second outer side surface 225, the first inner side surface 123 is coplanar with the second inner side surface 227, and the second top surface 125 is coplanar with the third top surface 229.

The optical fiber group 30 includes a plurality of core fibers 31 and a plurality of covering layers 32 covering the core fibers 31 correspondingly. The core fibers 31 include exposed ends 310. The optical fiber group 30 extends through the receiving space 24. The exposed ends 310 extend through the receiving grooves 119 and the receiving holes 117 and are exposed out of the first front surface 113 through the receiving holes 117.

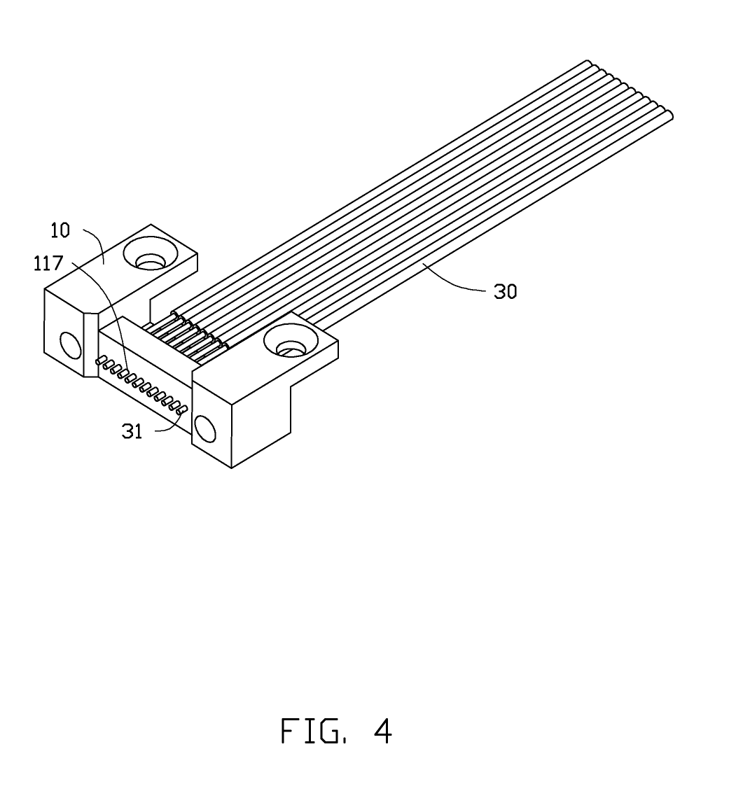

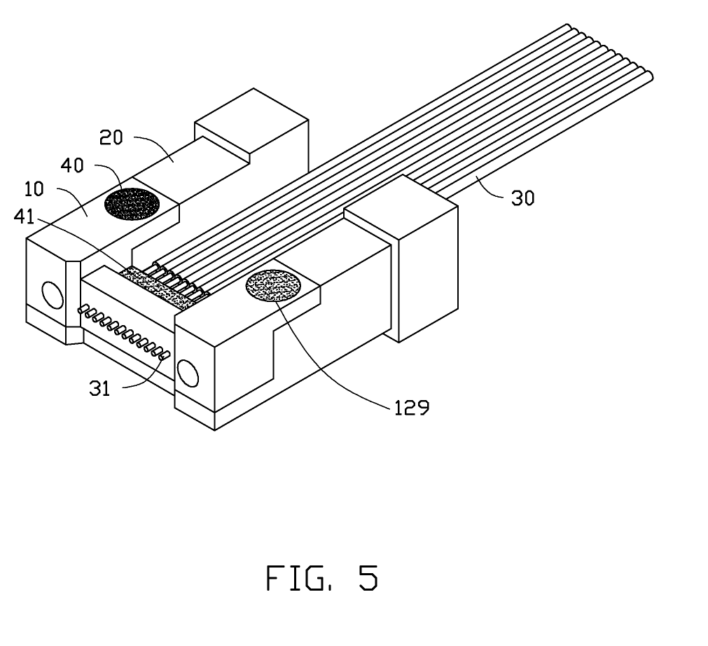

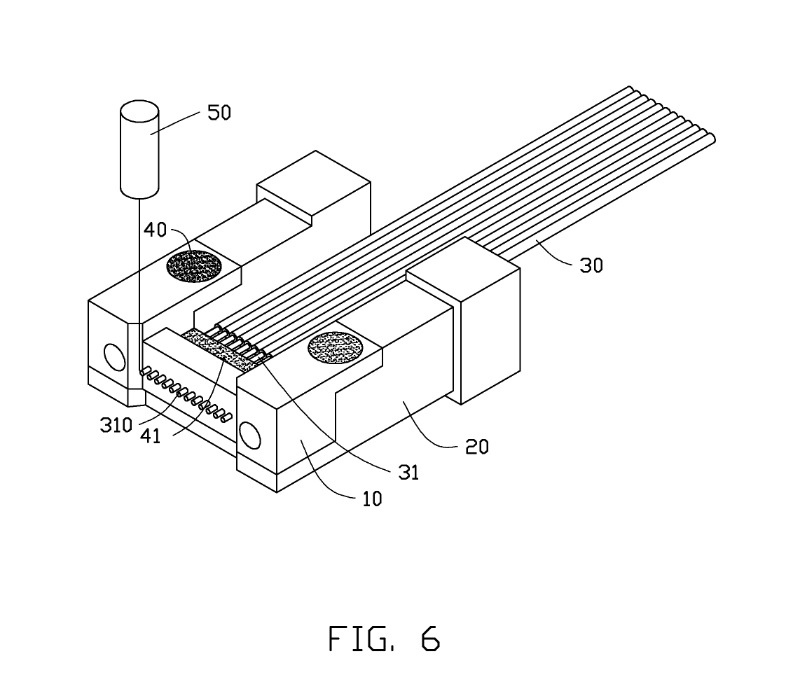

Referring to FIGS. 4 through 6, in assembly, the optical fiber group 30 is received in the receiving space 24 and the exposed ends 310 are received in the receiving holes 117. The clamping block 213 is received in the clamping hole 111. The connecting rods 223 are received in the stepped through holes 129. A curable glue 40 is filled into the stepped through holes 129, and a curable glue 41 is applied on the first top surface 115. Thus, the optical fiber group 30, the first body 10, and the second body 20 are fixed together. Finally, a laser-cutting machine 50 is used to trim portions of the exposed ends 310 of the core fibers 31 projecting out of the first front surface 113.

The optical fiber connector 100 is divided into the first body 10 for holding the optical fiber group 30, and the second body 20 for holding the first body 10. In this way, the optical fiber connector 100 is easy to manufacture.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An optical fiber connector comprising:
a first body defining a clamping groove and at least one stepped through hole;
a second body comprising a clamping block and at least one connecting rod, wherein a shape and a size of the clamping block are identical to a shape and a size of the clamping groove, the clamping block is inserted into the clamping groove, a size of the connecting rod is smaller than a size of the stepped through hole, the connecting rod is inserted into the stepped through hole;
a first curable glue filled in the stepped through hole to fixedly connect the first body to the second body; and
an optical fiber group fixed on the first body.

2. The optical fiber connector of claim 1, wherein the first body further defines at least one receiving hole, and the optical fiber group comprises at least one core fiber, the core fiber comprises an exposed end received in the receiving hole.

3. The optical fiber connector of claim 2, wherein the first body comprises an optical part and two connecting part extending from two opposite sides of the optical part, the receiving hole is defined in the optical part.

4. The optical fiber connector of claim 3, wherein each of the stepped through hole extends through one of the connecting parts.

5. The optical fiber connector of claim 3, wherein each of the connecting parts defines a insertion hole.

6. The optical fiber connector of claim 3, wherein the optical part and the connecting parts share a common bottom surface, the clamping groove is defined in the bottom surface.

7. The optical fiber connector of claim 1, further comprising a second curable glue for fixing the optical fiber group on the first body.

8. The optical fiber connector of claim 1, wherein the second body comprises a base and two sidewalls extending from two opposite sides of the base, the base and the sidewalls cooperatively form a receiving space for receiving the optical fiber group.

9. The optical fiber connector of claim 8, wherein the base comprises a first step and a first surface adjacent to the first step, the clamping block is formed on the first surface.

10. The optical fiber connector of claim 8, wherein each of the sidewalls comprises a second step and a second surface adjacent to the second step, and the connecting rod is formed on the second surface.
